(19) United States
(12) Patent Application Publication
(10) Pub. No.: US 2024/0394592 A1
(43) Pub. Date: Nov. 28, 2024

(54) CROSS-MODAL TRANSFER WITH CONTINUOUSLY WEIGHTED CONTRASTIVE LOSS

(71) Applicant: Samsung Electronics Co., Ltd., Suwon-si (KR)

(72) Inventors: Rakshith Sharma Srinivasa, Sunnyvale, CA (US); Jaejin Cho, Sunnyvale, CA (US); Chouchang Yang, San Jose, CA (US); Yashas Malur Saidutta, Menlo Park, CA (US); Ching-Hua Lee, Mountain View, CA (US); Yilin Shen, Mountain View, CA (US); Hongxia Jin, San Jose, CA (US)

(21) Appl. No.: 18/434,691

(22) Filed: Feb. 6, 2024

Related U.S. Application Data
(60) Provisional application No. 63/468,879, filed on May 25, 2023.
(60) Provisional application No. 63/530,646, filed on Aug. 3, 2023.

(51) Int. Cl. G06N 20/00

(52) U.S. Cl. CPC G06N 20/00

(57) ABSTRACT

A method includes accessing a training dataset having multiple samples, where each sample includes a data point for each of multiple modalities. The method also includes generating, using a first encoder associated with a first modality of the multiple modalities, first modality embeddings for data points of the first modality in the training dataset. The method further includes, for each first modality embedding, determining a similarity metric to other first modality embeddings. The method also includes generating, using a second encoder associated with a second modality of the multiple modalities, second modality embeddings for data points of the second modality in the training dataset. In addition, the method includes training the second encoder based on a contrastive loss function to align the first modality embeddings and the second modality embeddings from different samples of the training dataset, where the contrastive loss function is weighed using the similarity metrics.

### CROSS-REFERENCE TO RELATED APPLICATION AND PRIORITY CLAIM

This application claims priority under 35 U.S.C. § 119(e) to U.S. Provisional Patent Application No. 63/468,879 filed on May 25, 2023 and U.S. Provisional Patent Application No. 63/530,646 filed on Aug. 3, 2023, both of which are hereby incorporated by reference in their entirety.

### TECHNICAL FIELD

This disclosure relates generally to machine learning systems and processes. More specifically, this disclosure relates to cross-modal transfer with continuously weighted contrastive loss.

### BACKGROUND

Multimodal machine learning has seen significant progress in recent years, and many so-called multimodal “foundational models” are now part of mainstream technology. These multimodal models aim to learn a common representation space in which data from multiple modalities, such as vision, audio, and language, can interact with each other. Such multimodal models are trained using large-scale datasets, which are often scraped from the Internet. These datasets do not cater to any particular task but mainly offer examples of data from various modalities that are aligned with each other.

### SUMMARY

This disclosure relates to cross-modal transfer with continuously weighted contrastive loss.

In a first embodiment, a method includes accessing a training dataset having multiple samples, where each sample includes a data point for each of multiple modalities. The method also includes generating, using a first encoder associated with a first modality of the multiple modalities, first modality embeddings for data points of the first modality in the training dataset. The method further includes, for each first modality embedding, determining a similarity metric to other first modality embeddings. The method also includes generating, using a second encoder associated with a second modality of the multiple modalities, second modality embeddings for data points of the second modality in the training dataset. In addition, the method includes training the second encoder based on a contrastive loss function to align the first modality embeddings and the second modality embeddings from different samples of the training dataset, where the contrastive loss function is weighed using the similarity metrics.

In a second embodiment, an electronic device includes at least one processing device configured to access a training dataset having multiple samples, where each sample includes a data point for each of multiple modalities. The at least one processing device is also configured to generate, using a first encoder associated with a first modality of the multiple modalities, first modality embeddings for data points of the first modality in the training dataset. The at least one processing device is further configured, for each first modality embedding, to determine a similarity metric to other first modality embeddings. The at least one processing device is also configured to generate, using a second encoder associated with a second modality of the multiple modalities, second modality embeddings for data points of the second modality in the training dataset. In addition, the at least one processing device is configured to train the second encoder based on a contrastive loss function to align the first modality embeddings and the second modality embeddings from different samples of the training dataset, where the contrastive loss function is weighed using the similarity metrics.

In a third embodiment, a non-transitory machine-readable medium contains instructions that when executed cause at least one processor of an electronic device to access a training dataset having multiple samples, where each sample includes a data point for each of multiple modalities. The non-transitory machine-readable medium also contains instructions that when executed cause the at least one processor to generate, using a first encoder associated with a first modality of the multiple modalities, first modality embeddings for data points of the first modality in the training dataset. The non-transitory machine-readable medium further contains instructions that when executed cause the at least one processor, for each first modality embedding, to determine a similarity metric to other first modality embeddings. The non-transitory machine-readable medium also contains instructions that when executed cause the at least one processor to generate, using a second encoder associated with a second modality of the multiple modalities, second modality embeddings for data points of the second modality in the training dataset. In addition, the non-transitory machine-readable medium contains instructions that when executed cause the at least one processor to train the second encoder based on a contrastive loss function to align the first modality embeddings and the second modality embeddings from different samples of the training dataset, where the contrastive loss function is weighed using the similarity metrics.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example process for cross-modal transfer with continuously weighted contrastive loss according to this disclosure;

FIG. 3 illustrates a conventional contrastive loss technique;

FIG. 4 illustrates example details of a continuously weighted contrastive loss (CWCL) operation used in the process of FIG. 2 according to this disclosure;

FIGS. 5 and 6 illustrate example processes for multimodal machine learning model training with more than two modalities according to this disclosure;

FIG. 7 illustrates an example system for processing multiple modalities according to this disclosure;

FIG. 8 illustrates an example process using the system of FIG. 7 according to this disclosure;

FIG. 9 illustrates an example system for processing downstream speech tasks according to this disclosure; and

FIG. 10 illustrates an example method for cross-modal transfer with continuously weighted contrastive loss according to this disclosure.

### DETAILED DESCRIPTION

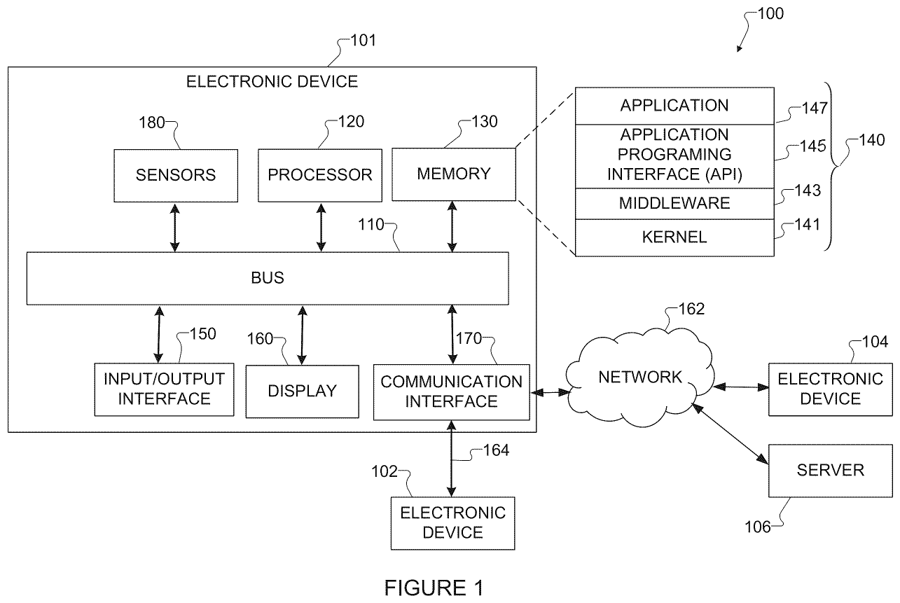

FIGS. 1 through 10, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As noted above, multimodal machine learning has seen significant progress in recent years, and many so-called multimodal “foundational models” are now part of mainstream technology. These multimodal models aim to learn a common representation space in which data from multiple modalities, such as vision, audio, and language, can interact with each other. Such multimodal models are trained using large-scale datasets, which are often scraped from the Internet. These datasets do not cater to any particular task but mainly offer examples of data from various modalities that are aligned with each other. Unfortunately, conventional techniques to train such models focus on individual pairs (or higher dimensional tuples) of data to teach cross-modal associations to the model, but this ignores any information offered by other pairs in the datasets. This leads to data and computing inefficiency, and thus higher training costs and data requirements.

Learning visual representations from natural language supervision has proven to be a powerful technique to achieve impressive zero-shot performance on a number of tasks, such as image classification, image and text retrieval, object identification, and visual question-answering. This disclosure discusses the task of cross-modal alignment for zero-shot transfer for multiple modalities or other cross-modal transfers. Let [symbol] and [symbol] denote a pair of modalities. For example, [symbol] may be a textual modality, and [symbol] may be a visual modality. The following problem is explored: given a pre-trained model f_{θ}: [symbol] → [symbol] for data in [symbol] (where [symbol] denotes the embedding space), how can a model g_{ϕ}: [symbol] → [symbol] (where [symbol] is the embedding space corresponding to [symbol] be learned so that the learned structure in the embedding space [symbol] can be aligned with that of [symbol] ? Once trained, the models f_{θ} and g_{ϕ} can be used on a diverse set of downstream tasks, such as in a zero-shot manner, thus avoiding the need for costly task-specific labeled datasets.

One motivation in studying the above problem lies in the fact that pre-trained models exist in certain modalities but are lacking in other modalities. For example, recent advances in language models have resulted in very powerful models to process text data, while no such models may exist for speech and audio data. Unlike text-based models that can be generalized to new tasks in a zero-shot way, speech and audio models are typically trained in a task-specific way.

Not only that, collecting labeled datasets in the speech domain offers its own set of challenges, including quality control, noise, and removing silence. Similarly, even when pre-trained models are available for certain modalities such as images, there may be challenging sub-modalities or domains, such as medical imaging, on which pre-trained models may not be trained. However, large scale paired datasets may be available, which connect the above modalities. For example, large datasets of speech and the associated (possibly noisy) transcripts are readily available on the Internet. Similarly, pairs of text and images and pairs of medical and raw text may be more readily available. Based on this observation, an image encoder and a text encoder may be trained to align features corresponding to paired image and text data. Upon training, these models may achieve zero-shot performance on a number of downstream tasks, such as image classification and image text retrieval. Both encoders may be trained from scratch, or a frozen pre-trained image classification model may be used as the image encoder and just the text encoder may be trained to boost the downstream zero-shot performance. The concept of using a pre-trained model in one modality as supervision to train a model in another modality using pairwise data may be applied to other pairs of modalities.

Training multimodal models to learn a common representation space for data from multiple modalities typically includes two parts, namely (i) learning transformations specific to each modality and (ii) aligning those modality-specific representations. The alignment is useful or important in training powerful models that can perform well on downstream tasks without any task-specific training (also called zero-shot transfer). Existing techniques make use of positive and negative examples to learn alignment by using pairwise data. Here, the training data includes pairs of data points, one from each modality. During the alignment, the positive example for a data point from one modality is simply the corresponding data point from the other modality, and negative examples are obtained using all other data points from other pairs. However, other training data pairs can potentially offer information crucial to alignment, as well.

Currently, there are two main techniques for performing multimodal alignments, namely self-supervised contrastive tuning and supervised contrastive training with multiple positive examples. With respect to self-supervised contrastive tuning, since most foundational multimodal models are trained in a task-agnostic way, the training datasets do not contain any “supervisory” labels or information but merely include pairs or tuples of data points from different modalities. For example, in the case of vision-language models, each pair includes an image and its caption. Hence, existing approaches mainly focus on self-supervised learning and use contrastive learning for representation learning by teaching the model to generate similar representations for similar data points and contrasting them against dissimilar data points. However, similarity is treated as binary with corresponding data from each pair treated as positive examples and all other data treated as negative or dissimilar examples.

With respect to supervised contrastive training with multiple positive examples, to address the drawback of self-supervised learning that uses only a single data point as a positive example and all other data points as negative examples, some supervised contrastive learning techniques utilize information from labels to identify other positive training examples. However, they assume availability of label information and hence can only work in supervised learning scenarios. Since most multimodal foundational models are trained in a task-agnostic way, such supervised techniques cannot be applied. Also, some classes might be more similar to each other than other classes. For example, although dog images and cat images in some datasets are labeled differently, they are more similar to each other than airplane images or shoe images.

While both of these techniques can provide good results in some situations, neither technique accounts for the continuous nature of similarity between various pairs of training data. As a result, they require large training datasets and have high resource requirements for training. Further, they treat similarity as binary and ignore the inter-pair associations in the training data. Hence, such techniques require more data, and their downstream performance is negatively affected.

This disclosure provides various techniques for cross-modal transfer with continuously weighted contrastive loss. As described in more detail below, the disclosed embodiments can improve the data and computing efficiency of training large multimodal models. For example, the disclosed embodiments feature novel techniques to train multimodal models that aim to learn a common representation space for data from multiple modalities. Using the disclosed techniques, multiple models can be trained on multiple datasets and modalities. These models when tested on various downstream tasks (without any further task-specific training) can outperform existing multimodal models. Moreover, the disclosed techniques result in better data and computing efficiency during training. Note that while some of the embodiments discussed below are described in the context of use in or with consumer electronic devices (such as smartphones), this is merely one example. It will be understood that the principles of this disclosure may be implemented in any number of other suitable contexts and may use any suitable devices.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform one or more operations for cross-modal transfer with continuously weighted contrastive loss.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for cross-modal transfer with continuously weighted contrastive loss as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an AR wearable device, such as a headset with a display panel or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations to support techniques for cross-modal transfer with continuously weighted contrastive loss.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

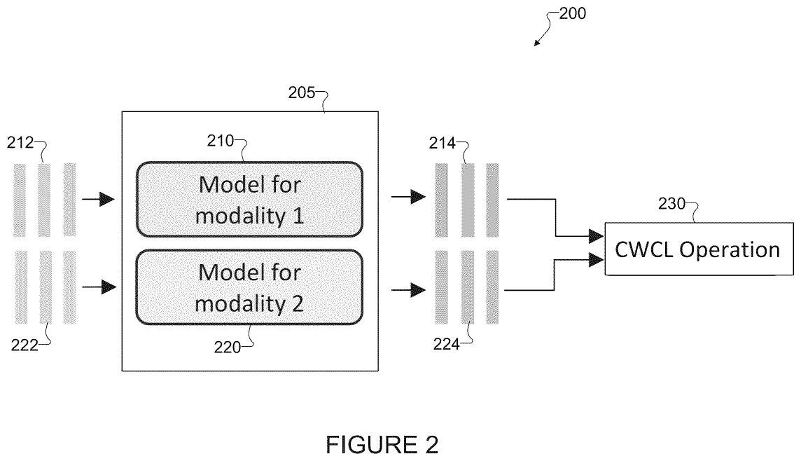

FIG. 2 illustrates an example process 200 for cross-modal transfer with continuously weighted contrastive loss according to this disclosure. For ease of explanation, the process 200 is described as being implemented using one or more components of the network configuration 100 of FIG. 1 described above, such as the server 106. However, this is merely one example, and the process 200 could be implemented using any other suitable device(s) (such as the electronic device 101) and in any other suitable system(s).

As shown in FIG. 2, the server 106 performs the process 200 using a multimodal machine learning (ML) model 205 that includes multiple models for multiple modalities. For example, the multimodal ML model 205 can include a first model 210 for a first modality (“modality 1,” which can be text, for example) and a second model 220 for a second modality (“modality 2,” which can be images, for example). In some embodiments, the multimodal ML model 205 may be trained “from scratch,” where the first model 210 and the second model 220 are trained with random initialization. Under such training, the models 210 and 220 derive their knowledge from multimodal data used for training. Such a training mechanism is useful when good pre-trained models are not available in any of the modalities under consideration. In other embodiments, one or both of the models 210 and 220 may be “pre-trained” models. Further, the models 210 and 220 may or may not be updated during training. Using pre-trained models can help to improve data and compute efficiency, as the models can leverage the representations learned during pre-training. Both of these approaches are suitable in the process 200 as they only address the representation learning stage and not the alignment stage.

To perform the process 200, the server 106 obtains training data samples 212 and 222. The training data samples 212 include data points for the first modality, and the training data samples 222 include data points for the second modality. The training data samples 212 and 222 can be arranged in pairs such that each data point of the training data samples 212 has a corresponding data point in the training data samples 222. The server 106 provides the training data samples 212 as input to the model 210 and uses the model 210 to obtain encoded embeddings 214. Similarly, the server 106 provides the training data samples 222 as input to the model 220 and uses the model 220 to obtain encoded embeddings 224. The encoded embeddings 214 and 224 are provided as input to a continuously weighted contrastive loss (CWCL) operation 230.

As described in greater detail below, the CWCL operation 230 includes a contrastive loss function for self-supervised and multi-modal learning. To better describe the CWCL operation 230, it is helpful to briefly summarize a conventional contrastive loss function. Such a conventional contrastive loss function can be used in both single-modality self-supervised learning as well as multi-modal alignment. Let [symbol] denote a batch of training data including pairs of data samples from two modalities of size N: [symbol] ={(uᵢ, vᵢ)} for i=1, . . . , N, where uᵢ is from modality [symbol] and vᵢ is from modality [symbol] . Let uᵢ and vᵢ be encoded into embeddings denoted as pᵢ, qᵢ respectively. This can be performed by separate modality-specific encoders or by a shared encoder or a hybrid version. The conventional contrastive loss (CL) function (to align [symbol] with [symbol] ) is defined over the training batch [symbol] as follows.

$${ℒ}_{CL , 𝒰 - 𝒱} = \frac{- 1}{N} {\sum }_{i = 1}^{N} log \frac{exp ( 〈 {p}_{i} , {q}_{j} 〉 / τ )}{{\sum }_{j ∈ [ N ]} exp ( 〈 {p}_{i} , {q}_{j} 〉 / τ )} \qquad ( 1 )$$

Here, [N] denotes the set {1, 2, . . . , N}, and τ is a temperature parameter. By minimizing Equation (1), the encoders learn to align pairs of data. In other words, contrastive learning aims to align pᵢ with qᵢ and misalign all other possible pairs (such as pᵢ, qⱼ where i≠j). Note that in doing so, for each uᵢ, vᵢ is considered to be a positive example, and all other samples {vᵢ}_{j∈[N],j≠i} are considered to be negative examples. However, this may lead to suboptimal learning and sometimes may also mislead the model. This is because of possible similarity between samples from other pairs. By misaligning such samples, existing techniques ignore useful information and may also incur penalties due to incorrect learning.

It is sometimes the case that in a given training batch, there is more than one “positive” sample. However, the information about which samples are related to each other may be missing in self-supervised learning. In contrast, this information can be available in a supervised learning setup. In that case, let [symbol] denote a batch of training data of size M including samples and labels: [symbol] {(xᵢ, yᵢ)}. Further, let zᵢ be the embedding generated by the model. It is clear that the set [symbol] ={(xⱼ, j≠i|, yᵢ=yᵢ)} forms a set of positive examples. For example, the following loss function may be used to leverage the label information.

$${ℒ}_{supcon} = \frac{- 1}{M} {\sum }_{i = 1}^{M} \frac{1}{\vert P ( i ) \vert} {\sum }_{j ∈ P ( i )} log \frac{exp ( 〈 {z}_{i} , {z}_{j} 〉 / τ )}{{\sum }_{k ∈ [ N ] , k \neq i} exp ( 〈 {z}_{i} , {z}_{k} 〉 / τ )} \qquad ( 2 )$$

Note that the loss function in Equation (2) can be interpreted as taking the average of pair-wise [symbol] _{CL} over the positive set. A combination of the above loss and the task loss can yield better performance than using the task loss alone. However, this approach involves the use of labeled datasets. In the loss functions in Equations (1) and (2) and other similar variants, there are various shortcomings. First, other similar examples that may be present in the training batch are not considered. In the self-supervised setting, all other similar samples are considered as negative examples. In the supervised setting, some classes might be similar to each other (such as for multiple breeds of dogs) but are considered to be negative examples to each other. Second, similarity is considered to be binary. As a result, all “positive examples” are attracted equally, and all “negative examples” are repelled equally.

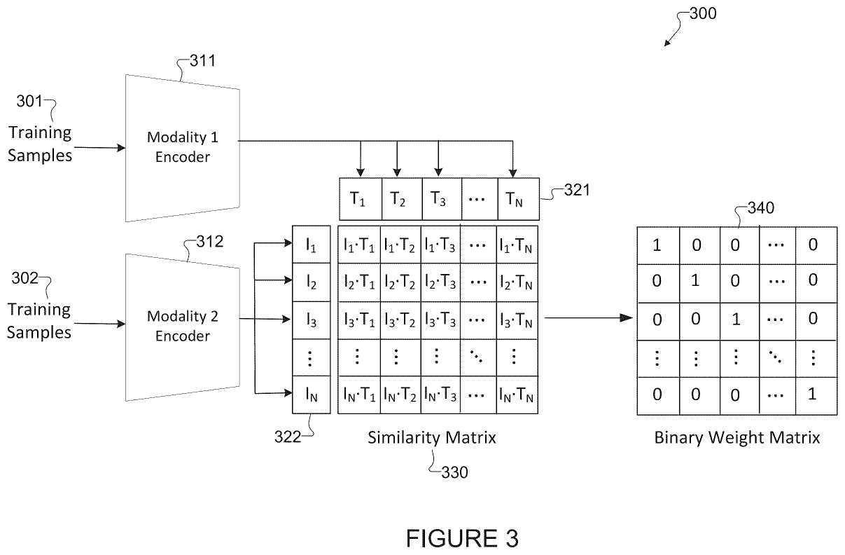

This can be seen in FIG. 3, which illustrates a conventional CL technique 300. As shown in FIG. 3, in the CL technique 300, training samples 301 and 302 from different modalities are input to separate modality encoders 311 and 312. Each encoder 311 and 312 generates a corresponding set of embeddings 321 and 322. The embeddings 321 and 322 are aligned in a similarity matrix 330 and evaluated for similarity. Similar samples are considered positive examples and are assigned a weight of one, while all other samples are considered negative samples and are assigned a weight of zero. The result is a binary weight matrix 340 with ones on the diagonal and zeros everywhere else. Similarity is considered to be binary, where all positive examples are attracted equally and all negative examples are repelled equally.

In reality, however, samples in a training batch may be similar to each other to varying degrees. Some samples might be more similar to each other, a few others might be less so, and many others may be dissimilar. To address this drawback, the CWCL operation 230 considers the relationship between various training data samples. In particular, the CWCL operation 230 uses intra-modal similarity to compute a similarity metric between all training data samples in each training batch.

When pre-trained models are available, they can be expected to encode similar examples approximately similarly. Therefore, in some embodiments of the CWCL operation 230, the server 106 can compute similarity metrics wᵢⱼ between various training data samples by measuring the similarity of the representations obtained using the models 210 and 220, which can be pre-trained. If the models 210 and 220 are not already pre-trained, the server 106 can compute the similarity metrics wᵢⱼ from the models 210 and 220 as the models 210 and 220 are being trained. By using the computed similarity metrics wᵢⱼ, the server 106 can align all similar examples in a batch of training data.

In the CWCL operation 230, the server 106 does not simply categorize training samples into binary sets of similar and dissimilar. Instead, the server 106 measures the similarity on a continuous scale (such as between zero and one) and aligns the training data samples 212 and 222 to a degree proportional to the corresponding similarity metric wᵢⱼ. This process can be captured mathematically, such as by using the following expression.

$${ℒ}_{CWCL} = \frac{- 1}{N} {\sum }_{i = 1}^{N} \frac{1}{{\sum }_{j ∈ [ N ]} {w}_{ij}} {\sum }_{j ∈ [ N ]} {w}_{ij} \cdot log \frac{exp ( 〈 {p}_{i} , {q}_{j} 〉 / τ )}{{\sum }_{k ∈ [ N ]} exp ( 〈 {p}_{i} , {q}_{k} 〉 / τ )} \qquad ( 3 )$$

Here, pᵢ denotes the first modality embedding obtained from the first encoder for an i^{th} sample in the training dataset, qⱼ denotes the second modality embedding obtained from the second encoder for a j^{th} sample in the training dataset, qₖ denotes the second modality embedding obtained from the second encoder for a k^{th} sample in the training dataset, wᵢⱼ denotes the similarity metric determined as a function of the embeddings pᵢ and pⱼ, N denotes a number of samples in a batch, and τ denotes the temperature parameter. The loss function in Equation (3) weights all samples in the training batch by their computed similarities. By minimizing the above loss function, the representation corresponding to the two modalities can be aligned well with each other.

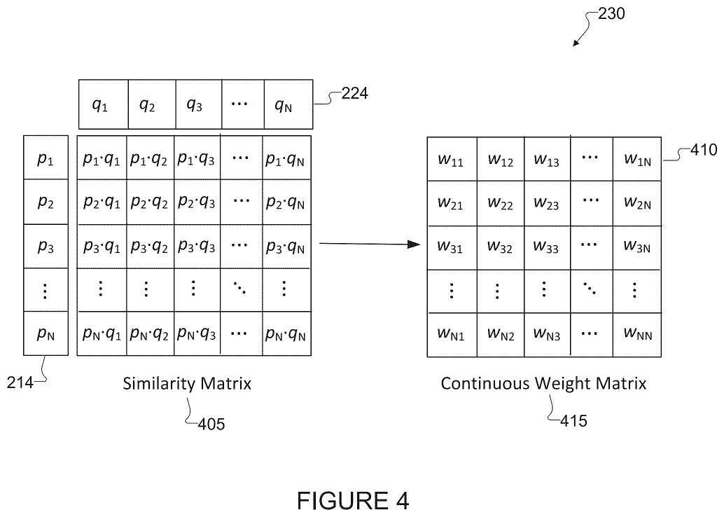

FIG. 4 illustrates example details of the CWCL operation 230 according to this disclosure. As shown in FIG. 4, the server 106 obtains the encoded embeddings 214 and 224 using the models 210 and 220. The embeddings 214 and 224 are aligned in a similarity matrix 405 and evaluated for similarity. The server 106 computes similarity metrics wᵢⱼ 410 for the pairs of the encoded embeddings 214 and 224. In some embodiments, the similarity metrics 410 may include a continuous weight matrix 415. In some cases, the CWCL operation 230 allows for wᵢⱼ to have any real value between zero and one inclusive, which accounts for the continuous nature of similarity between training samples.

In addition, the similarity metric wᵢⱼ may be determined such that the value of wᵢⱼ should be higher as the similarity between two training data points becomes higher, which may promote better alignment between modalities. In some embodiments, the server 106 uses the following function to compute the similarity metric between two training data points pᵢ and pⱼ.

$${w}_{ij} = f ( {p}_{i} , {p}_{j} ) = \frac{〈 {p}_{i} , {p}_{j} 〉}{2} + 0.5 \qquad ( 4 )$$

Here, [symbol] pᵢ, pⱼ [symbol] denotes the inner product of pᵢ and pⱼ. Since the inner product [symbol] pᵢ, pⱼ [symbol] lies between −1 and 1, Equation (4) ensures that the similarity metric wᵢⱼ has a value between zero and one.

It is noted that other functions for computing the similarity between training data points are possible and within the scope of this disclosure. For example, the function shown in Equation (4) can be replaced by any suitable function, such as one that has the following property: f(⋅)∈[0,1]. Here, f(⋅) is a monotonic function of similarity, meaning f increases as the similarity increases and f decreases as the similarity decreases.

In some embodiments, the models 210 and 220 are pre-trained models that are frozen when obtaining the representations pᵢ and pⱼ. However, it is also possible to update the model 210, the model 220, or both while still computing the similarity metrics wᵢⱼ using the original pre-trained models 210 and 220.

As seen from the discussion above, the CWCL operation 230 in some embodiments allows for wᵢⱼ to have any real value between zero and one inclusive, which accounts for the continuous nature of similarity between training samples. Hence, the CWCL operation 230 enables learning a richer sense of alignment between modalities, which results in better data and computing efficiency and results in better generalizability of the trained models 210 and 220 to downstream tasks.

Although FIGS. 2 through 4 illustrate one example of a process 200 for cross-modal transfer with continuously weighted contrastive loss and related details, various changes may be made to FIGS. 2 through 4. For example, while the process 200 is described as involving specific sequences of operations, various operations described with respect to FIG. 2 could overlap, occur in parallel, occur in a different order, or occur any number of times (including zero times). Also, the specific operations shown in FIG. 2 are examples only, and other techniques could be used to perform each of the operations shown in FIG. 2. In addition, the example matrices shown in FIG. 4 are for illustration and explanation only and do not limit this disclosure to any specific implementation.

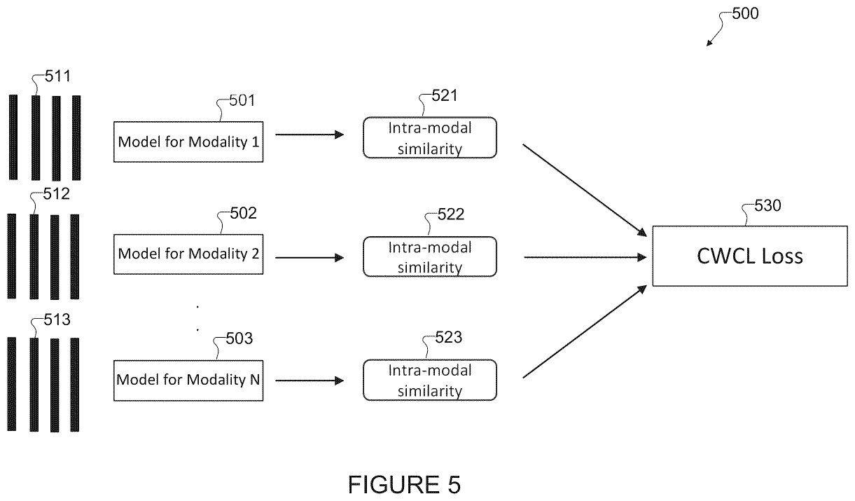

FIG. 5 illustrates an example process 500 for multimodal machine learning model training with more than two modalities according to this disclosure. For ease of explanation, the process 500 is described as being implemented using one or more components of the network configuration 100 of FIG. 1 described above, such as the server 106. However, this is merely one example, and the process 500 could be implemented using any other suitable device(s) (such as the electronic device 101) and in any other suitable system(s).

As shown in FIG. 5, the process 500 is a generalized version of the process 200 of FIG. 2, which has been expanded from two modalities to N modalities (where N is greater than two) such that cross-modal associations can be used effectively. In FIG. 5, N is equal to three, although values other than three are possible and within the scope of this disclosure.

In the process 500, the server 106 uses pre-trained models 501-503 to learn similarities between corresponding training data samples 511-513. The models 501-503 correspond to three different modalities, which in some cases may relate to video data (modality 1), audio data (modality 2), and text data such as subtitles or closed captioning text (modality 3). The training data samples 511-513 include samples for each modality such that the data points for each training data sample 511-513 are aligned with each other.

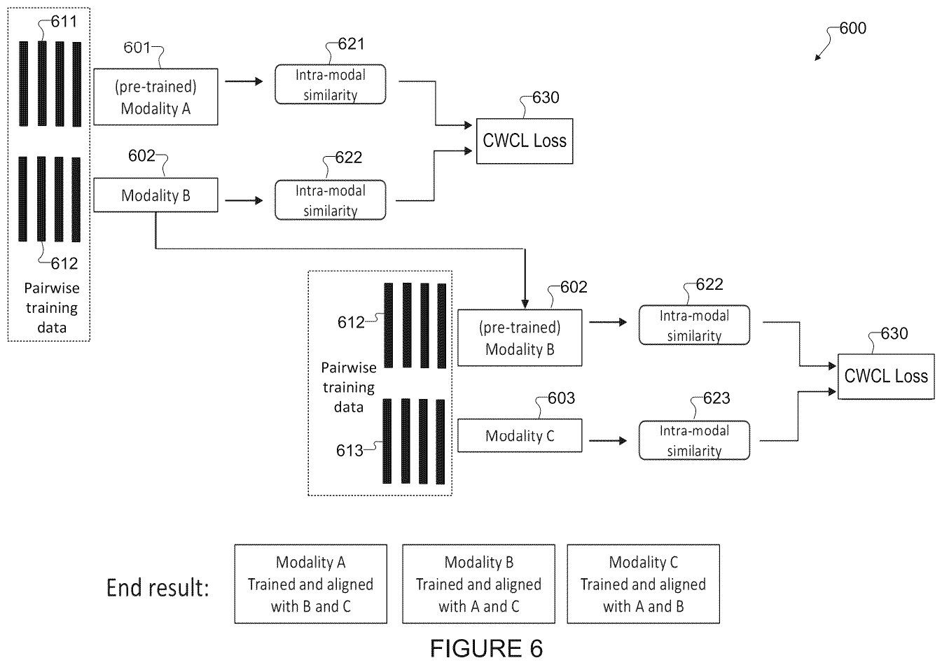

During training, the data points are passed through the corresponding models 501-503 by providing the individual modalities through separate modality-specific encoders. These modality encoders may be pre-trained or initialized from scratch. For each pre-trained model 501-503, the server 106 computes an intra-modal similarity metric wᵢⱼ 521-523 as described above if a pre-trained model is available for that modality. Otherwise, the server 106 sets the intra-modal similarity metric 521-523 to be wᵢⱼ=1 when i=j and wᵢⱼ=0 when i≠j. Once the similarity metrics wᵢⱼ 521-523 are computed, the server 106 aligns the representations across modalities using the similarity metrics wᵢⱼ 521-523 as weights. A CWCL loss 530 may be computed pair-wise across the modalities. Once trained, each modality-specific encoder can be used for downstream tasks without any further training. If a dataset with tuples of aligned modalities is not available for the process 500, the process 500 can be adapted for use with only pair-wise aligned datasets. Such an example is shown in FIG. 6, which is described below.

Although FIG. 5 illustrates one example of a process 500 for multimodal machine learning model training with more than two modalities and related details, various changes may be made to FIG. 5. For example, while the process 500 is described as involving specific sequences of operations, various operations described with respect to FIG. 5 could overlap, occur in parallel, occur in a different order, or occur any number of times (including zero times). Also, the specific operations shown in FIG. 5 are examples only, and other techniques could be used to perform each of the operations shown in FIG. 5.

FIG. 6 illustrates another example process 600 for multimodal machine learning model training with more than two modalities according to this disclosure. For ease of explanation, the process 600 is described as being implemented using one or more components of the network configuration 100 of FIG. 1 described above, such as the server 106. However, this is merely one example, and the process 600 could be implemented using any other suitable device(s) (such as the electronic device 101) and in any other suitable system(s).

As shown in FIG. 6, the process 600 includes various components that are the same as or similar to corresponding components of the process 500 of FIG. 5. In the process 600, the server 106 has access to an aligned dataset with training data samples 611 and 612 for modalities {A,B} and has an aligned dataset with training data samples 612 and 613 for modalities {B,C}. Initially, the server 106 can train a model 602 for modality B using the training data samples 611 and 612 for modalities {A,B} and a pre-trained model 601 for modality A. As in FIG. 5, during training, the server 106 computes intra-modal similarity metrics wᵢⱼ 621 and 622 for modalities A and B. Once the similarity metrics wᵢⱼ 621 and 622 are computed, the server 106 computes a CWCL loss 630 pair-wise across the modalities A and B. Subsequently, the server 106 can train a model 603 for modality C using the training data samples 612 and 613 for modalities {B,C} and the encoder of the model 602 (modality B) as the pre-trained model. During training, the server 106 computes intra-modal similarity metrics wᵢⱼ 622 and 623 for modalities B and C. Once the similarity metrics wᵢⱼ 622 and 623 are computed, the server 106 computes a CWCL loss 630 pair-wise across the modalities B and C. As a result, the server 106 obtains aligned models for all three modalities A, B and C.

Although FIG. 6 illustrates another example of a process 600 for multimodal machine learning model training with more than two modalities and related details, various changes may be made to FIG. 6. For example, while the process 600 is described as involving specific sequences of operations, various operations described with respect to FIG. 6 could overlap, occur in parallel, occur in a different order, or occur any number of times (including zero times). Also, the specific operations shown in FIG. 6 are examples only, and other techniques could be used to perform each of the operations shown in FIG. 6.

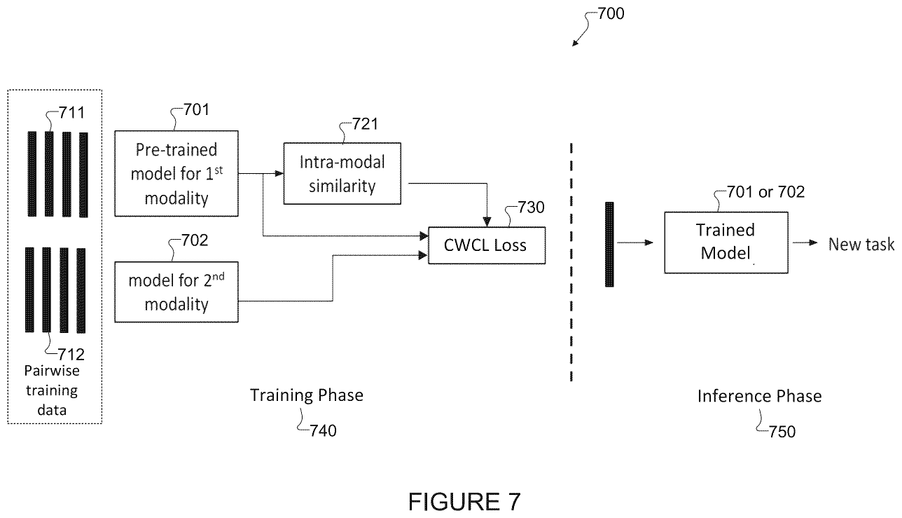

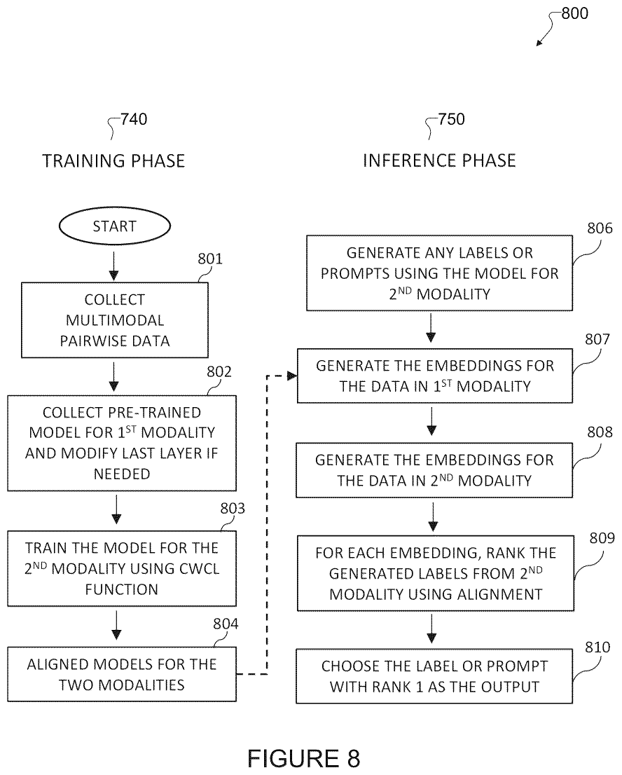

FIG. 7 illustrates an example system 700 for processing multiple modalities according to this disclosure. FIG. 8 illustrates an example process 800 using the system 700 according to this disclosure. For ease of explanation, the system 700 and the process 800 are described as being implemented using one or more components of the network configuration 100 of FIG. 1 described above, such as the server 106. However, this is merely one example, and the system 700 and the process 800 could be implemented using any other suitable device(s) (such as the electronic device 101) and in any other suitable system(s).

As shown in FIG. 7, the system 700 includes multiple models 701 and 702 for multiple modalities. While FIG. 7 shows two modalities, this is merely one example, and other embodiments could include more than two modalities. Each model 701 and 702 is a deep neural network or other machine learning model that can be trained to process a corresponding modality. The system 700 is designed to align the representation spaces of the two modalities, and the system 700 can be implemented in a training phase 740 and an inference phase 750. In the training phase 740, the model 702 is trained to align the two modalities. In some embodiments, the model 701 is a pre-trained model and may or may not be updated during training.

The training phase 740 includes step 801 in which a multimodal dataset having pairs of aligned data samples 711 and 712 from the two modalities is collected. It should be noted that larger datasets tend to provide better learning. At step 802, the pre-trained model 701 is identified. If pre-trained models are available for both modalities, the model trained with a larger dataset can be chosen to compute the similarity metrics. At step 803, the pre-trained model 701 is used to compute the intra-modal similarity metrics wᵢⱼ 721, and the model 702 is trained using the similarity metrics wᵢⱼ 721 by minimizing a CWCL loss function 730, such as one described above. At step 804, the models 701 and 702 are now trained and aligned for the two modalities. The result of the training phase 740 is a set of two models 701 and 702 that can process two different modalities but have a shared representation space. Hence, each of the models 701 and 702 gains “understanding” of the other's modality.

In the inference phase 750, each of the trained models 701 and 702 can be used for various downstream tasks without any need for further fine-tuning (such as a classification or retrieval task). The inference phase 750 includes steps 806-810, which will now be described with respect to the model 702. However, these steps 806-810 can also be performed with respect to the model 701. At step 806, labels or prompts are generated using the encoder of model 702. At step 807, the embeddings for the data in the first modality are generated. At step 808, the embeddings for the data in the second modality are generated. At step 809, for each embedding, the generated labels from the second modality are ranked using alignment. At step 810, the label or prompt with rank one is chosen as the output.

As discussed, in the inference phase 750, the way of performing a task changes to include calculating similarities of embedding pairs from two modalities. For example, image classification can be performed by calculating embeddings from images of interest and embeddings from a text label set of interest, after which each image embedding is compared to the text label embeddings to select the most similar text label embedding. In this way, image classification for any domain (such as medical, animal classification, or the like) can be performed without training a new classifier for a new domain or any task that can be done in the aforementioned way.

Although FIG. 7 illustrates one example of a system 700 for processing multiple modalities and FIG. 8 illustrates one example of a process 800 using the system 700, various changes may be made to FIGS. 7 and 8. For example, the configuration of the system 700 could include any number of each component in any suitable arrangement. Also, while the process 800 is described as involving specific sequences of operations, various operations described with respect to FIG. 8 could overlap, occur in parallel, occur in a different order, or occur any number of times (including zero times). In addition, the specific operations shown in FIG. 8 are examples only, and other techniques could be used to perform each of the operations shown in FIG. 8.

It should be noted that the techniques disclosed above do not update the pre-trained model used for encoding one of the modalities. However, these techniques can be extended by training models for multiple modalities. This can be performed in a couple of different ways. For example, in one approach, a pre-trained model may be used for one or both modalities. When a pre-trained model is available, the pre-trained model can be used to compute the similarity between training data points during training while also updating the model weights for both the modalities. In another approach, when pre-trained models are not available, a hybrid approach can be used where only corresponding data points are aligned in the initial stages of training. As the models learn, the models can be used to compute intra-modal similarity to align each data point with as many of the others as possible. As a result, only corresponding data points may be aligned in the beginning, but over the entire training the disclosed approach may be used by the end of the process.

While some of the embodiments disclosed above are described in the context of image and text modalities, other combinations of modalities are possible and within the scope of this disclosure. Some example pairs or triplets of modalities can include {audio, text}, {audio, images}, {audio, images, text}, and {video, text}. In some embodiments, audio signals considered in such applications may correspond to or include non-human audio, such as musical instruments. These models can be trained similarly as vision-language models and can be used for tasks such as audio event classification and musical instrument identification.

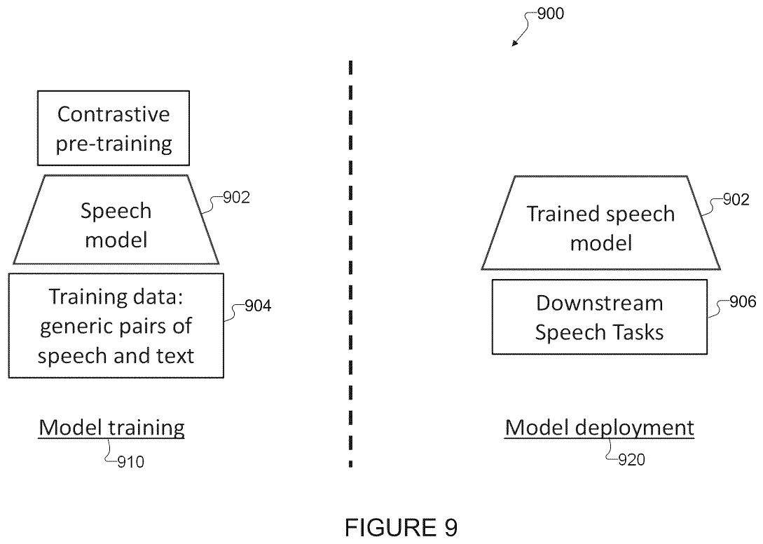

Learning aligned representations across different modalities is useful for many tasks, such as intent classification and keyword spotting in speech-text and image-text. For example, FIG. 9 illustrates an example system 900 for processing downstream speech tasks according to this disclosure. For ease of explanation, the system 900 is described as being implemented using one or more components of the network configuration 100 of FIG. 1 described above, such as the server 106. However, this is merely one example, and the system 900 could be implemented using any other suitable device(s) (such as the electronic device 101) and in any other suitable system(s).

As shown in FIG. 9, the system 900 can be implemented in a model training phase 910 and a model deployment phase 920. In the model training phase 910, the server 106 trains a speech encoder model 902 without requiring any task-specific training dataset. Once trained, the speech encoder model 902 can be used in the model deployment phase 920 for multiple downstream speech tasks 906 in a zero-shot way.

In this example, the system 900 can use the CWCL techniques discussed above to develop a multimodal model to align the modalities of speech and text. The model can include two encoders, namely the speech encoder model 902 and a text encoder model (not shown). In some embodiments, pre-trained speech and language models can be used for the speech and text encoders, respectively. In some cases, the system 900 may use a training dataset 904 that includes paired samples of speech utterances and corresponding transcriptions.

The resulting speech encoder model 902 shares its representation space with the pre-trained language model and hence can be considered to have “language understanding.” For example, the speech encoder model 902 can generate similar representations for the speech signals containing the phrases “switch on camera” and “take a picture.” This language understanding property can be leveraged to adapt the speech encoder model 902 to multiple speech tasks without any further fine-tuning. For instance, the trained speech model 902 can be used for various downstream speech tasks 906, such as speech-to-intent prediction and keyword spotting. While no task-specific data was used in training the model 902, the model 902 can achieve performance similar to other, task-specific models.

Although FIG. 9 illustrates one example of a system 900 for processing downstream speech tasks, various changes may be made to FIG. 9. For example, the configuration of the system 900 could include any number of each component in any suitable arrangement. Also, while the system 900 is described as involving specific sequences of operations, various operations described with respect to FIG. 9 could overlap, occur in parallel, occur in a different order, or occur any number of times (including zero times).

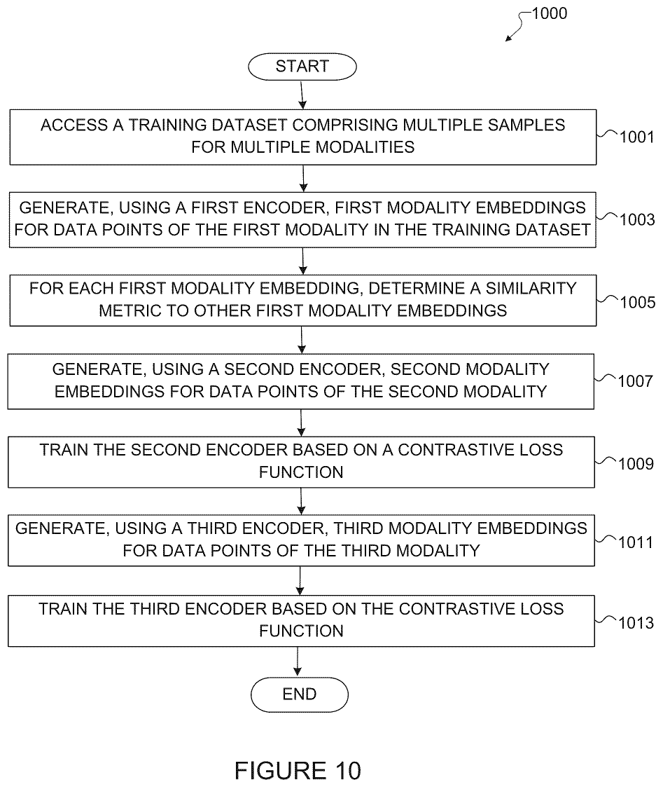

FIG. 10 illustrates an example method 1000 for cross-modal transfer with continuously weighted contrastive loss according to this disclosure. For ease of explanation, the method 1000 shown in FIG. 10 is described as being performed using the server 106 shown in FIG. 1 and one or more of the techniques shown in FIGS. 2 through 9. However, the method 1000 shown in FIG. 10 could be used with any other suitable device(s) or system(s) and could be used to perform any other suitable technique(s).

As shown in FIG. 10, at step 1001, a training dataset that includes multiple samples is accessed, where each sample includes a data point for each of multiple modalities. This could include, for example, the server 106 accessing the pair-wise training data samples 611 and 612 for modalities {A,B}, such as shown in FIG. 6. At step 1003, a first encoder associated with a first modality of the multiple modalities is used to generate first modality embeddings for data points of the first modality in the training dataset. This could include, for example, the server 106 using the encoder of the pre-trained model 601 to generate embeddings (such as the encoded embeddings 214) for modality A, such as shown in FIGS. 2 and 6.

At step 1005, for each first modality embedding, a similarity metric to other first modality embeddings is determined. This could include, for example, the server 106 determining intra-modal similarity metrics wᵢⱼ 621, such as shown in FIG. 6. At step 1007, a second encoder associated with a second modality of the multiple modalities is used to generate second modality embeddings for data points of the second modality in the training dataset. This could include, for example, the server 106 using the encoder of the model 602 to generate embeddings (such as the encoded embeddings 214) for modality B, such as shown in FIGS. 2 and 6.

At step 1009, the second encoder is trained based on a contrastive loss function to align the first modality embeddings and the second modality embeddings from different samples of the training dataset, where the contrastive loss function is weighed using the similarity metrics. This could include, for example, the server 106 training the encoder of the model 602 by computing a CWCL loss 630 pair-wise across the modalities A and B, such as is shown in FIG. 6 and Equation (3).

At step 1011, a third encoder associated with a third modality of the multiple modalities may optionally be used to generate third modality embeddings for data points of the third modality in the training dataset. This could include, for example, the server 106 using the encoder of the model 603 to generate embeddings (such as the encoded embeddings 214) for modality C, such as shown in FIGS. 2 and 6. At step 1013, the third encoder may optionally be trained based on the contrastive loss function, where the contrastive loss function is weighed using additional similarity metrics determined from the second modality. This could include, for example, the server 106 training the encoder of the model 603 by computing a CWCL loss 630 pair-wise across the modalities B and C, such as is shown in FIG. 6 and Equation (3).

Although FIG. 10 illustrates one example of a method 1000 for cross-modal transfer with continuously weighted contrastive loss, various changes may be made to FIG. 10. For example, while shown as a series of steps, various steps in FIG. 10 could overlap, occur in parallel, occur in a different order, or occur any number of times (including zero times).

Among other things, the disclosed techniques using a CWCL loss function can provide advantageous benefits, such as in zero-shot transfer performance. For example, the disclosed techniques can be used to obtain improved results during zero-shot image classification tasks, speech-to-intent classification tasks, and keyword spotting tasks. Moreover, the trained models may achieve comparable performance to models that are fully-supervised on task-specific datasets. Models trained using the disclosed techniques are data and compute-efficient and can achieve higher accuracies with fewer pairs of data samples during training. In addition, embeddings extracted from datasets of downstream tasks can show a significantly-improved sense of similarity for data from the same class, even when no label information is provided to the model.

The disclosed embodiments are suitable for a wide variety of use cases without task-specific training data. For instance, the disclosed embodiments can be used for seamless voice-based interactions in many devices, such as smart-glasses, smartphones, earbuds, and watches. The disclosed embodiments can also be used to avoid “chaining together” multiple systems for cross-modal applications, since the disclosed embodiments enable the development of end-to-end applications where input and output modalities can be different.

Note that the operations and functions shown in or described with respect to FIGS. 2 through 10 can be implemented in an electronic device 101, 102, 104, server 106, or other device(s) in any suitable manner. For example, in some embodiments, the operations and functions shown in or described with respect to FIGS. 2 through 10 can be implemented or supported using one or more software applications or other software instructions that are executed by the processor 120 of the electronic device 101, 102, 104, server 106, or other device(s). In other embodiments, at least some of the operations and functions shown in or described with respect to FIGS. 2 through 10 can be implemented or supported using dedicated hardware components. In general, the operations and functions shown in or described with respect to FIGS. 2 through 10 can be performed using any suitable hardware or any suitable combination of hardware and software/firmware instructions.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
accessing a training dataset comprising multiple samples, each sample comprising a data point for each of multiple modalities;
generating, using a first encoder associated with a first modality of the multiple modalities, first modality embeddings for data points of the first modality in the training dataset;
for each first modality embedding, determining a similarity metric to other first modality embeddings;
generating, using a second encoder associated with a second modality of the multiple modalities, second modality embeddings for data points of the second modality in the training dataset; and
training the second encoder based on a contrastive loss function to align the first modality embeddings and the second modality embeddings from different samples of the training dataset, wherein the contrastive loss function is weighed using the similarity metrics.

2. The method of claim 1, wherein the contrastive loss function is expressed as:
$${ℒ}_{CWCL} = \frac{- 1}{N} {\sum }_{i = 1}^{N} \frac{1}{{\sum }_{j ∈ [ N ]} {w}_{ij}} {\sum }_{j ∈ [ N ]} {w}_{ij} \cdot log \frac{exp ( \frac{〈 {p}_{i} , {q}_{j} 〉}{τ} )}{{\sum }_{k ∈ [ N ]} exp ( \frac{〈 {p}_{i} , {q}_{k} 〉}{τ} )}$$
where pᵢ denotes the first modality embedding obtained from the first encoder for an i^{th} sample in the training dataset, qⱼ denotes the second modality embedding obtained from the second encoder for a j^{th} sample in the training dataset, qₖ denotes the second modality embedding obtained from the second encoder for a kₜₕ sample in the training dataset, wᵢⱼ denotes the similarity metric determined as a function of the embeddings pᵢ and pⱼ, N denotes a number of samples in a batch, and τ denotes a temperature parameter.

3. The method of claim 2, wherein the similarity metric wᵢⱼ is expressed as:
$${w}_{ij} = \frac{〈 {p}_{i} , {p}_{j} 〉}{2} + 0.5$$
where pⱼ denotes the first modality embedding obtained from the first encoder for the j^{th} sample in the training dataset, and [symbol] pᵢ, pⱼ [symbol] denotes an inner product function of pᵢ and pⱼ.

4. The method of claim 1, further comprising:
generating, using a third encoder associated with a third modality of the multiple modalities, third modality embeddings for data points of the third modality in the training dataset; and
training the third encoder based on the contrastive loss function, wherein the contrastive loss function is weighed using additional similarity metrics determined from the second modality.

5. The method of claim 1, wherein the first encoder is pre-trained.

6. The method of claim 1, wherein the first encoder and the second encoder are encoders of a multimodal machine learning model.

7. The method of claim 1, wherein each of the multiple modalities comprises one of: video, images, audio, text, and sensor data.

8. An electronic device comprising:
at least one processing device configured to:
access a training dataset comprising multiple samples, each sample comprising a data point for each of multiple modalities;
generate, using a first encoder associated with a first modality of the multiple modalities, first modality embeddings for data points of the first modality in the training dataset;
for each first modality embedding, determine a similarity metric to other first modality embeddings;
generate, using a second encoder associated with a second modality of the multiple modalities, second modality embeddings for data points of the second modality in the training dataset; and
train the second encoder based on a contrastive loss function to align the first modality embeddings and the second modality embeddings from different samples of the training dataset, wherein the contrastive loss function is weighed using the similarity metrics.

9. The electronic device of claim 8, wherein the contrastive loss function is expressed as:
$${ℒ}_{CWCL} = \frac{- 1}{N} {\sum }_{i = 1}^{N} \frac{1}{{\sum }_{j ∈ [ N ]} {w}_{ij}} {\sum }_{j ∈ [ N ]} {w}_{ij} \cdot log \frac{exp ( \frac{〈 {p}_{i} , {q}_{j} 〉}{τ} )}{{\sum }_{k ∈ [ N ]} exp ( \frac{〈 {p}_{i} , {q}_{k} 〉}{τ} )}$$
where pᵢ denotes the first modality embedding obtained from the first encoder for an i^{th} sample in the training dataset, qⱼ denotes the second modality embedding obtained from the second encoder for a j^{th} sample in the training dataset, qₖ denotes the second modality embedding obtained from the second encoder for a k^{th} sample in the training dataset, wᵢⱼ denotes the similarity metric determined as a function of the embeddings pᵢ and pⱼ, N denotes a number of samples in a batch, and τ denotes a temperature parameter.

10. The electronic device of claim 9, wherein the similarity metric wᵢⱼ is expressed as:
$${w}_{ij} = \frac{〈 {p}_{i} , {p}_{j} 〉}{2} + 0.5$$
where pⱼ denotes the first modality embedding obtained from the first encoder for the j^{th} sample in the training dataset, and [symbol] pᵢ, pⱼ [symbol] denotes an inner product function of pᵢ and pⱼ.

11. The electronic device of claim 8, wherein the at least one processing device is further configured to:
generate, using a third encoder associated with a third modality of the multiple modalities, third modality embeddings for data points of the third modality in the training dataset; and
train the third encoder based on the contrastive loss function, wherein the contrastive loss function is weighed using additional similarity metrics determined from the second modality.

12. The electronic device of claim 8, wherein the first encoder is pre-trained.

13. The electronic device of claim 8, wherein the first encoder and the second encoder are encoders of a multimodal machine learning model.

14. The electronic device of claim 8, wherein each of the multiple modalities comprises one of: video, images, audio, text, and sensor data.

15. A non-transitory machine-readable medium containing instructions that when executed cause at least one processor of an electronic device to:
access a training dataset comprising multiple samples, each sample comprising a data point for each of multiple modalities;
generate, using a first encoder associated with a first modality of the multiple modalities, first modality embeddings for data points of the first modality in the training dataset;
for each first modality embedding, determine a similarity metric to other first modality embeddings;
generate, using a second encoder associated with a second modality of the multiple modalities, second modality embeddings for data points of the second modality in the training dataset; and
train the second encoder based on a contrastive loss function to align the first modality embeddings and the second modality embeddings from different samples of the training dataset, wherein the contrastive loss function is weighed using the similarity metrics.

16. The non-transitory machine-readable medium of claim 15, wherein the contrastive loss function is expressed as:
$${ℒ}_{CWCL} = \frac{- 1}{N} {\sum }_{i = 1}^{N} \frac{1}{{\sum }_{j ∈ [ N ]} {w}_{ij}} {\sum }_{j ∈ [ N ]} {w}_{ij} \cdot log \frac{exp ( \frac{〈 {p}_{i} , {q}_{j} 〉}{τ} )}{{\sum }_{k ∈ [ N ]} exp ( \frac{〈 {p}_{i} , {q}_{k} 〉}{τ} )}$$
where pᵢ denotes the first modality embedding obtained from the first encoder for an i^{th} sample in the training dataset, qⱼ denotes the second modality embedding obtained from the second encoder for a j^{th} sample in the training dataset, qₖ denotes the second modality embedding obtained from the second encoder for a k^{th} sample in the training dataset, wᵢⱼ denotes the similarity metric determined as a function of the embeddings pᵢ and pⱼ, N denotes a number of samples in a batch, and τ denotes a temperature parameter.

17. The non-transitory machine-readable medium of claim 16, wherein the similarity metric wᵢⱼ is expressed as:
$${w}_{ij} = \frac{〈 {p}_{i} , {p}_{j} 〉}{2} + 0.5$$
where pⱼ denotes the first modality embedding obtained from the first encoder for the j^{th} sample in the training dataset, and [symbol] pᵢ, pⱼ [symbol] denotes an inner product function of pᵢ and pⱼ.

18. The non-transitory machine-readable medium of claim 15, wherein the instructions when executed further cause the at least one processor to:
generate, using a third encoder associated with a third modality of the multiple modalities, third modality embeddings for data points of the third modality in the training dataset; and
train the third encoder based on the contrastive loss function, wherein the contrastive loss function is weighed using additional similarity metrics determined from the second modality.

19. The non-transitory machine-readable medium of claim 15, wherein the first encoder is pre-trained.

20. The non-transitory machine-readable medium of claim 15, wherein the first encoder and the second encoder are encoders of a multimodal machine learning model.
